(19) United States
(12) Patent Application Publication
(10) Pub. No.: US 2026/0099340 A1
(43) Pub. Date: Apr. 9, 2026

(54) CUSTOM OPERATING SYSTEM GENERATION FOR RESOURCE-CONSTRAINED COMPUTING SYSTEMS

(71) Applicant: RED HAT, INC., Raleigh, NC (US)

(72) Inventors: Leigh Griffin, Waterford (IE); Luigi Mario Zuccarelli, Milan (IT); Gianluca Zuccarelli, Dublin (IE)

(21) Appl. No.: 18/909,513

(22) Filed: Oct. 8, 2024

(51) Int. Cl. G06F 9/445; G06F 9/4401

(52) U.S. Cl. CPC G06F 9/44505; G06F 9/4406

(57) ABSTRACT

A system can be provided for generating a custom operating system for a resource-constrained computing system. For example, the system can generate the custom operating system by importing a kernel comprising kernel features and a set of baseline packages comprising dependencies. The system can further modify the kernel by removing at least one of the kernel features from the kernel and can modify the set of baseline packages by removing at least one of the dependencies from the set of baseline packages. Additionally, the system can deploy the custom operating system with the modified kernel and the modified set of baseline packages on the computing system.

### TECHNICAL FIELD

The present disclosure relates generally to operating systems. More specifically, but not by way of limitation, this disclosure relates to generating a custom operating system for a resource-constrained computing system.

### BACKGROUND

Computing systems can use operating systems to manage system processes and resources, both software and hardware. An operating system can coordinate access to a computing system’s central processing unit (CPU, memory, and storage). An image (e.g., an image file) of the operating system can be captured and stored in a storage device of the computing system. The image can include multiple layers of software or libraries, along with metadata indicating a relationship between the layers.

### BRIEF DESCRIPTION OF THE DRAWINGS

FIG. 1 is a block diagram of an example of a computing environment for generating a custom operating system for a resource-constrained computing system, according to some aspects of the present disclosure.

FIG. 2 is a block diagram of another example of a computing environment for generating a custom operating system for a resource-constrained computing system, according to some aspects of the present disclosure.

FIG. 3 is a flow chart of an example of a method for generating a custom operating system for a resource-constrained computing system, according to some aspects of the present disclosure.

### DETAILED DESCRIPTION

Current operating systems (OS) (e.g., a Linux Operating system) may be unsuitable for resource-constrained computing systems, such as IoT and wearable devices. The current OS may be unsuitable due to the current OS requiring more computing resources (e.g., memory, CPU, power, and storage) to run efficiently than is available on the resource-constrained computing systems. Consequently, implementing current OS at the resource-constrained computing systems can cause various performance issues, security vulnerabilities, excessive memory usage, or the like on the resource-constrained computing systems. One solution to the issue of using current OS on resource-constrained computing systems involves stripping down the current OS to remove kernel features that may not be useful for operation on a resource-constrained computing system. However, this solution often results in an inefficient OS that is not compatible with the resource-constrained computing system. For example, the current OS may be designed to operate on a more powerful processor than a processor of the resource-constrained computing system. In consequence, even with kernel features (e.g., software packages) removed, the current OS may demand more CPU than is available on the resource-constrained computing system. Additionally, it may not be possible to install custom software packages or otherwise customize the current OS, which may prevent execution of or cause performance issues (e.g., latency) for software applications on the resource-constrained computing systems.

Some examples of the present disclosure can overcome one or more of the abovementioned problems by generating a custom OS for a resource-constrained computing system. More specifically, some examples of the present disclosure can overcome one or more of the abovementioned problems by generating the custom OS for the resource-constrained computing system from a baseline. The baseline from which the custom OS is generated may include a kernel, a set of baseline packages, one or more custom software packages for a specific use-case associated with the custom OS (e.g., custom software packages associated with software applications to be executed on the custom OS), and a bootloader program. It may then be determined (e.g., via load tests) whether the custom OS satisfies one or more computing resource constraints of the resource-constrained computing system, whether the software applications execute efficiently on the custom OS, or a combination thereof. If it is determined that the custom OS does not satisfy a computing resource constraint of the resource-constrained computing system or that a software application is not executing efficiently (e.g., experiencing latency or other performance issue) on the custom OS, the custom OS can be fine-tuned (e.g., by removing kernel features from the kernel, removing dependencies from the set of baseline packages, or otherwise modifying or removing features from the custom OS). The custom OS may be generated, evaluated, and modified in a cyclical manner until a most efficient version of the custom OS (e.g., a version that satisfies the resource constraints and enables efficient execution of the software applications) is generated. Thus, examples of the present disclosure enable generation of a streamlined, secure, and efficient OS for resource-constrained computing systems that is customizable to workloads (e.g., the software applications) associated with the resource-constrained computing systems.

In a particular example, an OS build engine can generate a custom WebAssembly (WASM) OS from a baseline for a resource-constrained computing system (e.g., a smart watch). The custom WASM OS may be generated by the OS build engine generating a kernel with kernel features (e.g., support for drivers, support for file systems, virtual memory, etc.). Additionally, the custom WASM OS may be generated by the OS build engine generating a set of baseline packages with various dependencies (e.g., software components or libraries used for the basic function of each baseline package). The kernel and the set of baseline packages may be generated based on one or more configuration files. For example, there may be configuration files associated with the smart watch as well as configuration files associated with WASM software applications to be executed on the smart watch.

The OS build engine may generate the kernel by importing, from a repository for example, a kernel configuration file. The kernel configuration file can include source code for a lightweight kernel that can be used with the smart watch. The OS build engine may then configure the kernel using the kernel configuration file. For example, the OS build engine may enable or disable predefined kernel features defined in the kernel configuration file. Similarly, the OS build engine may generate the set of baseline packages by inferring, from the configuration files associated with the smart watch and the configuration files associated the WASM software applications, a minimum set of software packages for the custom WASM OS to function on the smart watch and execute the WASM software applications (e.g., the set of baseline packages). The OS build engine may then import the set of baseline packages from a software package repository or package manager.

Once the kernel and the set of baseline packages are generated, the OS build engine may fine-tune the custom WASM OS by modifying the kernel, the set of baseline packages, or the combination thereof. The OS build engine may fine-tune the custom WASM OS until a resource-constraint of the smart watch is met. For example, the resource-constraint may be that the size of the custom WASM OS should be 350 Mb or less. To satisfy the resource-constraint the OS build engine may modify the kernel by removing at least one of the kernel feature from the kernel, may modify the set of baseline packages by removing at least one of the dependencies from the set of baseline packages, or a combination thereof. In doing so, the OS build engine can adapt the custom WASM OS to run efficiently on the smart watch.

The OS build engine may further install custom software packages as part of generating the custom WASM OS. The custom software packages may be useful for proper execution of the WASM software applications. The OS build engine may determine which custom software packages to install based on the configuration files associates with the WASM software applications. The OS build engine may also install a boot loader program as part of generating the custom WASM OS. Additionally, the OS build engine may build and implement a WASM runtime and WASM specification configurations to enable the custom WASM OS to execute the WASM software applications. Then, once the custom WASM OS is generated, the OS build engine may deploy the custom WASM OS with the modified kernel and the modified set of baseline packages on the smart watch.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

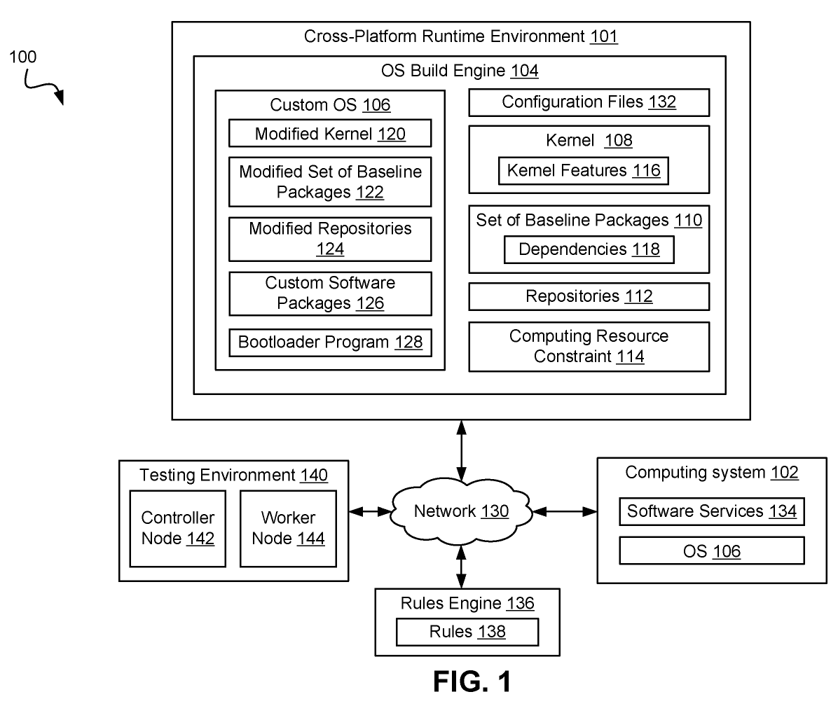

FIG. 1 is a block diagram of an example of a computing environment 100 for generating a custom operating system (OS) for a resource-constrained system, according to some aspects of the present disclosure. Components within the computing environment 100 may communicate using a network 130, such as the Internet or other suitable wide area network. The components of the computing environment 100 can include a computing system 102, an OS build engine 104, a testing environment 140, and a rules engine 136. The computing environment 100 can be any type of computing environment such as, but not limited to, an edge computing environment, a distributed computing environment, a cloud computing environment, a personal computing environment, or the like. The computing system 102 can be any suitable computing system in which computing resources (e.g., processing power, memory, storage, power supply) are constrained (e.g., limited). Examples of the computing system 102 can include servers, routers, controllers, microcontrollers, smart devices, sensors, smartphones, tablets, wearable devices, vehicles, Internet of Things (IoT) devices, etc. Additional examples of the computing system 102 can include non-physical devices, such as virtual machines or containers.

The computing environment 100 can further include a cross-platform runtime environment 101. The OS build engine 104 can build (e.g., generate) a custom OS 106 in the cross-platform runtime environment 101. Examples of the cross-platform runtime environment 101 include WebAssembly (WASM), Java Virtual Machine (JVM), .NET Common Language Runtime (CLR), CPython, Docker, or the like.

To generate the custom OS 106, the OS build engine 104 can generate a kernel 108. To do so, the OS build engine may import a kernel 108 (e.g., by importing a kernel configuration file) from a repository or other location in which kernel configuration files are stored. The kernel 108 can be a lightweight, baseline kernel that includes basic functionality for a lightweight operating system. In some examples, the kernel 108 may be a unikernel. The kernel 108 may be selected and imported by the OS build engine 104 based on the computing system 102 such that the kernel 108 is compatible (e.g., executable) with the computing system 102.

Kernels may generally be defined as computer programs that serve as a core component of an OS. Thus, a kernel may be used to manage communication between hardware components (e.g., microprocessors, storage devices, sensors, communication modules, I/O devices, and batteries) and software components (e.g., firmware, task scheduling, networking protocols, security services, power management software, and drivers) of the computing system 102. Additionally, a kernel may be used to manage computing resources of the computing system 102 (e.g., CPU, memory, and I/O devices) to enable software services 134 (e.g., software applications, microservices, or the like) to execute in an efficient manner.

Generating the kernel 108, can further include the OS build engine 104 modifying the kernel 108 to generate a modified kernel 120. The kernel 108 may include various kernel features 116, which can each play a role in managing one or more software components, hardware components, computing resources, or a combination thereof of the computing system 102. The OS build engine 104 may modify the kernel 108 by removing at least one of the kernel features 116 from the kernel 108. A kernel feature may be removed from the kernel 108 by the OS build engine 104 modifying the kernel configuration file to disable the kernel feature or to make the kernel feature a loadable module. Disabling a kernel feature can remove it from a corresponding kernel. Alternatively, making a kernel feature a loadable module can enable the kernel feature to be loaded into the corresponding kernel later if desired.

The kernel 108 can be modified based on the hardware components (e.g., based on the types of hardware components included in the computing system 102 or based on the versions of the hardware components) of the computing system 102. The kernel may additionally or alternatively be modified based on the software services 134 to be executed on the computing system 102. For example, the kernel 108 can be modified to include kernel features (e.g., virtual memory, device drivers, support for certain file systems, access control lists, etc.) useful for carrying out workloads of the software services 134 and to excluded kernel features (e.g., graphical user interface support, support for other file systems, networking features, etc.) that are not useful for carrying out the workloads. Moreover, the kernel 108 can be modified based on resource constraints (e.g., available memory, CPU, etc.) of the computing system 102. For example, some kernel features can be removed to reduce memory usage of the modified kernel 120 in comparison with the kernel 108. Security requirements associated with the computing system 102 or with the software services 134 to be executed on the computing system may also affect how the kernel 108 is modified. For example, a kernel feature (e.g., USB core support) may be removed to prevent unauthorized access to the computing system 102 via a USB device.

Kernel features that can be removed from the kernel 108 include device drivers for hardware components that are not part of the computing system 102. For example, if the computing system 102 does not have sound or multi-media functionality, device drivers for audio devices can be removed from the kernel 108 when generating the modified kernel 120. Additional examples of kernel features that may be removed from the kernel 108 to generate the modified kernel 120 include kernel features that support certain file systems (e.g., NTFS, EFS, etc.), kernel features that support certain networking protocols (e.g., Bluetooth, DCCP, etc.), kernel features related to power management (e.g., CPU frequency scaling), or any other kernel feature that is not necessary for the modified kernel 120 to function properly at the computing system 102. The kernel features may be deemed unnecessary for the modified kernel 120 to function properly at the computing system 102 due to the kernel features being associated with hardware or software components that are not part of the computing system 102, due to the kernel features adding capability to the kernel 108 that is not necessary to execute the software services 134 at the computing system 102, or for other reasons.

In some examples, once some of the kernel features 116 are removed from the kernel 108 (e.g., by modifying the kernel configuration file to disable some the kernel features 116), the modified kernel configuration file can be saved and compiled to generate the modified kernel 120. By removing unnecessary kernel features to generate the modified kernel 120, the modified kernel 120 can run faster than the kernel 108 and may therefore execute the software services 134 on the computing system 102 in a more efficient manner than if the kernel 108 was used to execute the software services on the computing system 102. Additionally, by removing unnecessary kernel features, the modified kernel 120 can utilize less memory and disk space of the computing system 102 than the kernel 108. A boot time of the computing system 102 can be faster with the modified kernel 120 than with the kernel 108 and maintenance (e.g., troubleshooting and updating) of the modified kernel 120 can be easier to perform due to there being fewer kernel features to initialize and maintain. Moreover, removing unnecessary kernel features can enhance security of the computing system 102 by eliminating potential vulnerabilities associated with unused kernel features. Thus, the OS build engine 104 can generate a streamlined, secure, and efficient kernel (i.e., the modified kernel 120) as part of generating the custom OS 106.

The OS build engine 104 can further generate a set of baseline packages 110. The set of baseline packages 110 can be a minimum set of software packages for basic functionality and operation of the custom OS 106. That is, the set of baseline packages 110 can include the fundamental software components for booting the custom OS 105, managing the hardware components, interacting with the network 130, etc. Some examples of baseline packages can include a shell (i.e., a command interpreter), basic system utilities to provide command-line functionality, tools for networking functionality (e.g., ping or netstat), a package manager for managing software installation, updates, and removal, library files, etc. The set of baseline packages 110 can be generated by the OS build engine 104 determining a minimum set of software packages for basic functionality and operation of the custom OS 106 and then importing the minimum set of software packages from a repository, package manager, or the like.

The OS build engine 104 can further modify the set of baseline packages 110 to generate a modified set of baseline packages 122. The set of baseline packages 110 can be modified to remove one or more dependencies. For example, the OS build engine 104 may determine that the custom OS 106 can operate and execute the software services 134 without one of the baseline packages 122. Consequently, the baseline package and its dependencies can be removed from the set of baseline packages 122. Additionally, one or more dependencies of one or more baseline packages 122 may become unnecessary due to system updates or configuration changes. For example, dependencies of a baseline package may change due to an update to the baseline package. But, some of the previous dependencies for the previous version of the baseline package may be installed. Thus, OS build engine can detect and remove the previous dependencies that are associated with the previous version of the baseline package and unnecessary for a current version of the baseline package. Moreover, in some examples, some of the baseline packages may have the same or similar dependencies. Thus, duplications of dependencies may also be removed from the set of baseline packages 110. To detect and remove the dependencies, the OS build engine 104 may include or be communicatively coupled with a package manager. The package manager can include features such as RPM package manager, Dandified YUM (DNF), Advanced Package tool (APT), or the like for detecting and removing unused or duplicated dependencies. In some examples, the OS build engine 104 may transmit a request to the package manager that includes indications of the dependencies to be removed. Then, in response to receiving the request, the package manager can remove (e.g., uninstall) the dependencies.

Similar to the above, removing unnecessary (e.g., unused or redundant) dependencies of the set of baseline packages 110, reduces resource requirements of the custom OS 106, thereby enabling the custom OS 106 to run faster and execute the workloads associated with the software services in a more efficient manner. Removing unnecessary dependencies can further improve stability of the custom OS 106 by reducing potential system conflicts and by eliminating potential security vulnerabilities associated with the removed dependencies. Thus, the OS build engine 104 can generate a streamlined and secure set of baseline packages for the custom OS 106 that is tailored to the computing system 102.

Additionally, the OS build engine 104 can import one or more repositories 112. The repositories 112 imported can be the minimal number and types of repositories for the custom OS 106 to function. In one example, the repositories 112 include a base repository containing software packages that enable the custom OS 106 to boot and function and an update repository containing security and bug fix updates for the software packages in the base repository. Examples of the software packages in the base repository may include kernel software packages, system libraries, drivers, basic utilities, package manager tools, system initialization tools, etc. In some examples, some software packages or other portions of the repositories 112 may be removed by the OS build engine 104 to further improve resource consumption of the custom OS 106 and therefore performance of the software services. Thus, the custom OS 106 may include modified versions of the repositories 112 (e.g., shown by modified repositories 124 in FIG. 1).

In some examples, the custom OS 106 may at least be partially prebuilt, and may therefore include additional features. For example, the kernel 108 (or the kernel configuration file) imported may include additional features. The OS build engine 104 may remove some of the additional features to further reduce resource consumption of the custom OS 106 and to optimize performance of the software services 134. Examples of such additional features can include “systemd” and secure shell (SSH).

The OS build engine 104 may determine which kernel features to remove from the kernel 108, which dependencies to remove from the set of baseline packages 110, which contents or portions of the repositories 112 to remove, which additional features of the custom OS 106 to remove, or a combination thereof based on one or more configuration files 132. For example, the OS build engine 104 may extract information about the hardware components of the computing system 102 from one or more configuration files associated with the computing system 102. Such information can include which types of hardware components are included in the computing system 102, version information for the hardware components, capabilities of the hardware components, or the like. Additionally or alternatively, the OS build engine 104 may extract information about the software services 134 from one or more configuration files associated with each of the software services 134. Such information can include settings, parameters, and dependencies that the custom OS 106 may need to have for proper execution of the software services 134. For example, the information may indicate libraries or frameworks the custom OS 106 should include, kernel settings or modules the modified kernel 120 of the custom OS 106 should include, resources permissions the custom OS 106 should provide the software services 134, network protocols used by the software services 134, amounts of computing resources (e.g., memory and CPU) to be allocated to the software services 134, etc.

In some examples, the OS build engine 104 may add custom software packages 126 to the custom OS 106. The OS build engine 104 may derive the custom software packages 126 to add to the custom OS 106 from the one or more configuration files 132 for the software services 134. In this way, the custom OS 106 can be compatible with and tailored to the software services 134 to be executed on the computing system 102.

In some examples, a rules-based approach can be implemented to determine what changes to make to the custom OS 106 (e.g., to the kernel, baseline packages, repositories, additional features, or a combination thereof of the OS). For example, a rules engine 136 associated with the OS build engine 104 can include rules 138. The rules 138 can indicate whether a kernel feature, dependency, etc. should be included or excluded (e.g., disabled) from the custom OS 106 based on some criteria (e.g., based on a configuration setting in one of the configuration files 132). Therefore, the rules engine 136 can facilitate generation of the modified kernel 120, the modified set of baseline packages 122, and one or more modified repositories 124 that are each modified to be streamlined, secure, and resource efficient. To do so, the rules engine 136 may be part of (e.g., may be communicatively coupled with) the OS build engine 104. As such, the OS build engine 104 may build a streamlined, secure, and computing resource efficient custom OS for the computing system 102.

To ensure the custom OS 106 can be used at the computing system 102, OS build engine 104 may further install bootloader software in the custom OS 106. Examples of the bootloader software include Grand Unified Bootloader (GRUB), Linus Loader (LILO), Syslinux/Extlinux, Windows Boot Manager, UEFI bootloader, or the like. Additionally, the OS build engine 104 may specify a partition (e.g., a logical division of a storage device of the computing system 102) for the custom OS 106.

Once the custom OS 106 is generated, the OS build engine 104 can facilitate testing and fine-tuning of the custom OS 106. In some examples, testing and fine-tuning the custom OS 106 can involve the OS build engine 104 deploying the custom OS 106 in a testing environment 140. In one example, the OS build engine 104 deploying the custom OS 106 in the testing environment 140 involves deploying the custom OS 106 on at least two devices (e.g., on a controller node 142 and a worker node 144). The OS build engine 104 may be communicatively coupled with the controller node 142, the worker node 144, or the combination thereof via the network 130. The OS build engine 104 may cause the controller node 142 to deploy the software services 134 at the worker node 144 and can run load tests as the software services 134 execute at the worker node 144. The OS build engine 104 may further cause the controller node 142 to stop execution of the software services 134, shut down the worker node 144, and update the custom OS 106 (e.g., by performing further modifications to the modified kernel 120 or to the modified set of baseline packages 122). The controller node 142 may update the custom OS 106 based on update requests transmitted by the OS build engine 104 to the controller node 142. The update requests can include indications of additional kernel features, dependencies, etc. for controller node 142 the remove from the custom OS 106.

In some examples, the OS build engine 104 can continually cause the controller node 142 to execute the software services 134, run load tests, and update the custom OS 106 until a failure occurs. A version of the custom OS 106 before the failure can then be the version used at the computing system 102. In other words, a previous round of updates made by the controller node 142 to the custom OS 106 before the failure may be rolled back (e.g., by reinserting the removed kernel features or dependencies) such that the version of the custom OS 106 before those changes is used at the computing system 102. The reinserting of the removed kernel features can include reenabling the features via the kernel configuration file while reinserting dependencies can involve reinstalling previously uninstalled or deleted dependencies. To do so, in some examples, the OS build engine 104 may transmit a request to the package manager that includes indications of the dependencies to be reinstalled. Then, in response to receiving the request, the package manager can reinstall the dependencies.

In other examples, the OS build engine 104 can continually cause the controller node 1042 to execute the software services, run load tests, and update the custom OS 106 until a computing resource constraint 114 is satisfied. For example, the computing resource constraint 114 can be a computing resource threshold (e.g., an amount of memory, CPU, etc.). Thus, determining that the computing resource constraint 114 is satisfied can involve determining, via the load tests, that a size or computing resource requirement of the custom OS does not exceed the computing resource threshold.

As mentioned above, the OS build engine 104 can transmit update requests to the controller node 142 to indicate additional modifications for the controller to make to the custom OS 106. To formulate the update requests, rules 138 generated by the rules engine 136 in a hierarchal manner may be used. For example, in a first round of kernel, baseline package, and repository modification, the OS build engine 104 can implement the modifications based on a first set of rules from the rules engine 136. The first set of rules be associated with a highest level of kernel, baseline package, and repository modification. Then, if during testing, a failure does not occur or a resource constraint is not satisfied, the OS build engine 104 can generate and transmit an update request based on a second set of rules. The second set of rules can be more specific than the first set of rules such that the update request based on the second set of rules cause the controller node 142 to further refine the custom OS 106. Once the custom OS 106 has been refined and tested, the OS build engine 104 may deploy the custom OS 106 at the computing system 102 to facilitate execution of the software services 134.

The example shown in FIG. 1 is illustrative, but various modifications are possible. For example, while FIG. 1 depicts a specific arrangement of components, other examples can include more components, fewer components, different components, or a different arrangement of the components shown in FIG. 1. Additionally, any component or combination of components depicted in FIG. 1 can be used to implement the process(es) described herein. Further, while certain components are depicted in FIG. 1 as being internal or external to the computing system 102, other examples can involve other configurations of the components. For example, the OS build engine 104, the rules engine 136, or any combination of these can be part of the from the computing system 102 or can be separate from and accessible to the computing system 102 via the network 130 (as shown).

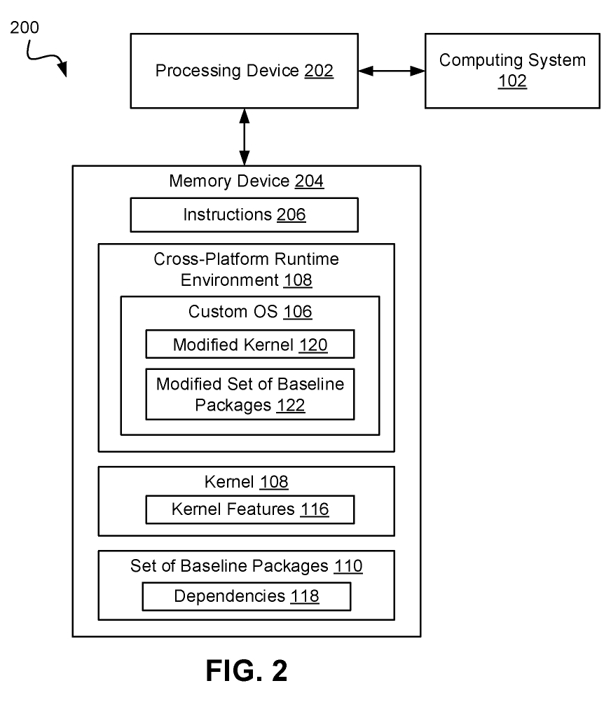

FIG. 2 is a block diagram of another example of a computing environment 200 for generating an operating system (OS) for a resource-constrained computing system (e.g., computing system 102), according to some aspects of the present disclosure. The computing environment 200 can include a processing device 202 communicatively coupled to a memory device 204. In some examples, the processing device 202 and the memory device 204 can be housed in a single device. In other examples, the processing device 202 and the memory device 204 can be distributed from one another.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

In some examples, the memory device 204 can store instructions 206 that can be executable by the processing device 202 to generate an OS. For example, the processing device 202 may generate the custom OS 106 for computing system 102 in a cross-platform runtime environment 101. The processing device 202 may generate the custom OS 106 by importing a kernel 108 comprising a plurality of kernel features 116 and by importing a set of baseline packages 110 comprising a plurality of dependencies 118. The processing device 202 can further generate the custom OS 106 by generating a modified kernel 120 by removing at least one kernel feature of the plurality of kernel features 116 from the kernel 108 and by generating a modified set of baseline packages 122 by removing at least one dependency of the plurality of dependencies 118 from the set of baseline packages 110. The processing device 202 may further deploy the custom OS 106 comprising the modified kernel 120 and the modified set of baseline packages 122 on the computing system 102.

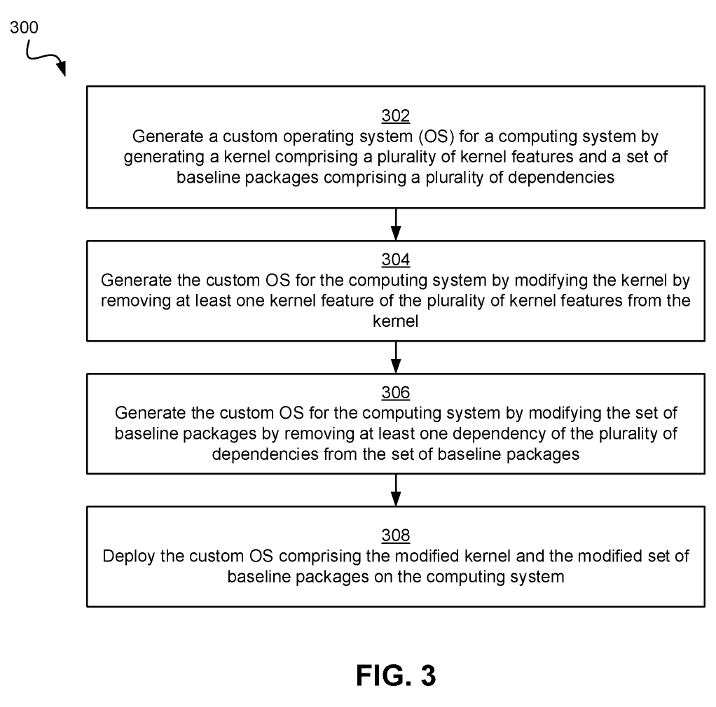

FIG. 3 is a flow chart of an example of a method 300 for generating an operating system (OS) for a resource-constrained computing system, according to some aspects of the present disclosure. In one example, the processing device 202 can execute the OS build engine 104, the rules engine 136, or a combination thereof of FIG. 1 to perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

At block 302, the processing device 202 can generate a custom operating system (OS) 106 for a computing system by generating a kernel 108 comprising a plurality of kernel features 116 and a set of baseline packages 110 comprising a plurality of dependencies 118. The processing device 202 can generate the custom OS 106 in a cross-platform runtime environment 101 such as WebAssembly (WASM), Java Virtual Machine (JVM), .NET Common Language Runtime (CLR), CPython, Docker, or the like. The kernel features 116 can include any software component of the kernel 108 that plays a role in managing one or more software components, hardware components, computing resources, or a combination thereof (e.g., support for drivers, support for file systems, virtual memory, etc.). The set of baseline packages can be the minimal set of software packages for basic functionality and operation of the custom OS 106. The dependencies 118 of the set of baseline packages 110 can be any software component or library used for the basic function of each baseline package. The kernel 108 may be generated by importing the kernel (or a kernel configuration file) from a kernel repository or similar location. Generating the kernel 108 may further include configuring the kernel 108, such as by adding, removing, or changing configuration settings defined in the kernel configuration file. Generating the set of baseline packages may include determining, from configuration files associated with the computing system 102 or configuration files associated software services 134, the minimum set of software packages for the custom OS 106 to function on the computing system 102 and execute the software services 134. The OS build engine 104 may then import the determined set of baseline packages from a software package repository or package manager.

At block 304, the processing device 202 can generate the custom OS 106 for the computing system 102 by modifying the kernel 108 by removing at least one kernel feature of the plurality of kernel features 116 from the kernel 108. The processing device 202 may determine the at least one kernel feature to remove from the kernel 108 one or more configuration files. For example, based on configuration files for the computing system 102, the processing device 202 may determine that support for certain drivers or other kernel features can be removed. The kernel features may be removed by amending a kernel configuration file associated with the kernel 108 to disable the features.

At block 306, the processing device 202 can generate the custom OS 106 for the computing system by generating a modified set of baseline packages 122 by removing at least one dependency of the plurality of dependencies 118 from the set of baseline packages 110. The processing device 202 may determine the dependency to remove from the set of baseline packages 110 based on there being duplications of the dependency across the set of baseline packages 110.

At block 308, the processing device 202 can deploy the custom OS 106 comprising the modified kernel 120 and the modified set of baseline packages 122 on the computing system 102. By deploying the custom OS 106 with the modified kernel 120 and the modified set of baseline packages 122, the processing device 202 deploys a streamlined version of the custom OS 106 to facilitate improved performance of the software services 134 on the computing system 102.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. The examples disclosed herein may be combined or rearranged to yield additional examples.

What is claimed is:

1. A system comprising:
a processing device; and
a memory device including instructions that are executable by the processing device for causing the processing device to perform operations comprising:
generating, in a cross-platform runtime environment, a custom operating system for a computing system by:
generating, based on one or more configuration files, a kernel comprising a plurality of kernel features and a set of baseline packages comprising a plurality of dependencies;
modifying the kernel by removing at least one kernel feature of the plurality of kernel features from the kernel; and
modifying the set of baseline packages by removing at least one dependency of the plurality of dependencies from the set of baseline packages; and
deploying the custom operating system comprising the modified kernel and the modified set of baseline packages on the computing system.

2. The system of claim 1, wherein the operations further comprise, subsequent to generating the custom operating system and prior to deploying the custom operating system on the computing system:
determining that the custom operating system satisfies at least one computing resource constraint of the computing system.

3. The system of claim 1, wherein the operations further comprise, subsequent to generating the custom operating system and prior to deploying the custom operating system on the computing system:
determining that the custom operating system does not satisfy at least one computing resource constraint of the computing system; and
in response to determining the custom operating system does not satisfy the at least one computing resource constraint, modifying the kernel by removing at least one additional kernel feature of the plurality of kernel features or modifying the set of baseline packages by removing at least one additional dependency of the plurality of dependencies.

4. The system of claim 1, wherein the operations further comprise, subsequent to generating the custom operating system and prior to deploying the custom operating system on the computing system:
deploying the custom operating system in a testing environment;
executing one or more software services on the custom operating system in the testing environment; and
detecting whether a failure occurs while executing the one or more software services on the custom operating system in the testing environment.

5. The system of claim 4, wherein the operations further comprise, in response to detecting that a failure does not occur while executing the software services on the custom operating system in the testing environment:
modifying the kernel by removing at least one additional kernel feature of the plurality of kernel features or modifying the set of baseline packages by removing at least one additional dependency of the plurality of dependencies.

6. The system of claim 4, wherein the operations further comprise, in response to detecting a failure while executing the software services on the custom operating system in the testing environment:
modifying the kernel by reinserting the at least one kernel feature into the kernel or modifying the set of baseline packages by reinserting the at least one dependency into the set of baseline packages.

7. The system of claim 1, wherein the operation of generating the custom operating system further comprises:
installing custom software packages associated with one or more software services to be executed on the custom operating system and installing a bootloader program.

8. A method comprising:
generating, by a processing device and in a cross-platform runtime environment, a custom operating system for a computing system by:
generating, by the processing device and based on one or more configuration files, a kernel comprising a plurality of kernel features and a set of baseline packages comprising a plurality of dependencies;
modifying, by the processing device, the kernel by removing at least one kernel feature of the plurality of kernel features from the kernel; and
modifying, by the processing device, the set of baseline packages by removing at least one dependency of the plurality of dependencies from the set of baseline packages; and
deploying, by the processing device, the custom operating system comprising the modified kernel and the modified set of baseline packages on the computing system.

9. The method of claim 8, further comprising, subsequent to generating the custom operating system and prior to deploying the custom operating system on the computing system:
determining that the custom operating system satisfies at least one computing resource constraint of the computing system.

10. The method of claim 8, further comprising, subsequent to generating the custom operating system and prior to deploying the custom operating system on the computing system:
determining that the custom operating system does not satisfy at least one computing resource constraint of the computing system; and
in response to determining the custom operating system does not satisfy the at least one computing resource constraint, modifying the kernel by removing at least one additional kernel feature of the plurality of kernel features or modifying the set of baseline packages by removing at least one additional dependency of the plurality of dependencies.

11. The method of claim 8, further comprising, subsequent to generating the custom operating system and prior to deploying the custom operating system on the computing system:
deploying the custom operating system in a testing environment;
executing one or more software services on the custom operating system in the testing environment; and
detecting whether a failure occurs while executing the one or more software services on the custom operating system in the testing environment.

12. The method of claim 11, further comprising, in response to detecting that a failure does not occur while executing the software services on the custom operating system in the testing environment:
modifying the kernel by removing at least one additional kernel feature of the plurality of kernel features or modifying the set of baseline packages by removing at least one additional dependency of the plurality of dependencies.

13. The method of claim 11, further comprising, in response to detecting a failure while executing the software services on the custom operating system in the testing environment, modifying the kernel by reinserting the at least one kernel feature into the kernel or modifying the set of baseline packages by reinserting the at least one dependency into the set of baseline packages.

14. The method of claim 8, wherein the generating the custom operating system further comprises:
installing custom software packages associated with one or more software services to be executed on the custom operating system and installing a bootloader program.

15. A non-transitory computer-readable medium comprising instructions that are executable by a processing device for causing the processing device to perform operations comprising:
generating, in a cross-platform runtime environment, a custom operating system for a computing system by:
generating, based on one or more configuration files, a kernel comprising a plurality of kernel features and a set of baseline packages comprising a plurality of dependencies;
modifying the kernel by removing at least one kernel feature of the plurality of kernel features from the kernel; and
modifying the set of baseline packages by removing at least one dependency of the plurality of dependencies from the set of baseline packages; and
deploying the custom operating system comprising the modified kernel and the modified set of baseline packages on the computing system.

16. The non-transitory computer-readable medium of claim 15, wherein the operations further comprise, subsequent to generating the custom operating system and prior to deploying the custom operating system on the computing system:
determining that the custom operating system satisfies at least one computing resource constraint of the computing system.

17. The non-transitory computer-readable medium of claim 15, wherein the operations further comprise, prior to deploying the custom operating system on the computing system:
determining that the custom operating system does not satisfy at least one computing resource constraint of the computing system; and
in response to determining that the custom operating system does not satisfy the at least one computing resource constraint, modifying the kernel by removing at least one additional kernel feature of the plurality of kernel features or modifying the set of baseline packages by removing at least one additional dependency of the plurality of dependencies.

18. The non-transitory computer-readable medium of claim 15, wherein the operations further comprise, prior to deploying the custom operating system on the computing system:
deploying the custom operating system in a testing environment;
executing one or more software services on the custom operating system in the testing environment; and
detecting whether a failure occurs while executing the one or more software services on the custom operating system in the testing environment.

19. The non-transitory computer-readable medium of claim 18, wherein the operations further comprise, in response to detecting that a failure does not occur while executing the software services on the custom operating system in the testing environment:
modifying the kernel by removing at least one additional kernel feature of the plurality of kernel features or modifying the set of baseline packages by removing at least one additional dependency of the plurality of dependencies.

20. The non-transitory computer-readable medium of claim 18, wherein the operations further comprise, in response to detecting a failure while executing the software services on the custom operating system in the testing environment:
modifying the kernel by reinserting the at least one kernel feature into the kernel or modifying the set of baseline packages by reinserting the at least one dependency into the set of baseline packages.
